(19) United States
(12) Patent Application Publication
(10) Pub. No.: US 2008/0302014 A1
(43) Pub. Date: Dec. 11, 2008

(54) Method and apparatus for positioning a motor actuated vehicle accessory

(75) Inventors: Joseph F. Szczerba, Grand Blanc, MI (US); John K. Lenneman, Okemos, MI (US); Roy J. Mathieu, Rochester Hills, MI (US); Brian S. Repa, Beverly Hills, MI (US); Thomas A. Seder, Northville, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/758,028

(22) Filed: Jun. 5, 2007

(51) Int. Cl. E05F 15/00; G06F 3/044

(52) U.S. Cl. 49/31; 178/18.06

(57) ABSTRACT

A method and apparatus are disclosed for positioning a motor actuated vehicle accessory. A vehicle window having a touch receptive field is used to detect touch events of a touch command applied by a vehicle occupant. A control unit, which is coupled to the touch receptive field and the motor actuated vehicle accessory, operates to position the motor actuated vehicle accessory in accordance with the touch command applied by the vehicle occupant. Exemplary embodiments are presented where the principles of the invention are applied to the positioning of a power window, a power mirror, and a power sunroof window of a vehicle.

### TECHNICAL FIELD

The present invention relates to a method and apparatus for positioning a movable vehicle accessory, and more particularly, to the use of a touch receptive field on a vehicle window and touch commands applied by a vehicle occupant for adjusting the positioning of a motor actuated vehicle accessory.

### BACKGROUND OF THE INVENTION

Over the past several years, the number and type of motor actuated vehicle accessories has been steadily increasing. Power windows, power mirrors, power sunroof windows, and numerous other kinds of electric motor actuated accessories are now common place in vehicles. This had led to an increase in the number and complexity of manually operated electrical contact switches required in vehicle cockpits to enable vehicle occupants to adjust the positioning of such accessories.

The placement and location of these manual switches can present difficulties to vehicle designers, and over extended periods of use, the performance of the switches can deteriorate. In addition, such switches are sometimes used to provide multiple switching functions for controlling different accessories, which can be confusing to vehicle occupants.

Accordingly, there exists a need for a more intuitive and user-friendly method and apparatus for adjusting the position of motor actuated vehicle accessories that do not require the use of manually operated electrical contact switches.

### SUMMARY OF THE INVENTION

The present invention obviates the above-described limitations and disadvantages associated with the use of manually operated electrical contact switches for adjusting the positioning of motor actuated vehicle accessories. This is accomplished by utilizing a vehicle window having a touch receptive field. The touch receptive field is used to detect touch commands applied by a vehicle occupant. A control unit, which is coupled to the touch receptive field and the motor actuated vehicle accessory, operates to position the motor actuated vehicle accessory in accordance with the touch command applied by the vehicle occupant. Touch commands that are both intuitive and user-friendly can be easily implemented with the present invention to simplify the operation of such vehicle accessories, without the use of manually operated electrical contact switches.

Exemplary embodiments are provided, wherein the principles of the present invention are applied to the positioning of a power window, an exterior power mirror, and a power sunroof window of a vehicle.

### BRIEF DESCRIPTION OF THE DRAWINGS

The present invention will now be described in the following detailed description with reference to the accompanying drawings. Like reference characters designate like or similar elements throughout the drawings in which:

FIG. 1 is a schematic diagram illustrating an exemplary embodiment of the present invention;

FIG. 2 is a block diagram showing components of the control unit depicted in FIG. 1;

FIG. 3 is a flow diagram illustrating operational steps carried out by the embodiment of the inventions shown in FIGS. 1 and 2;

FIGS. 4A and 4B illustrate exemplary touch events that are incorporated into touch commands employed by the present invention;

FIG. 5 illustrates a vehicle power window as an exemplary motor actuated vehicle accessory for implementing the present invention;

FIG. 6 illustrates a vehicle power mirror as an exemplary motor actuated vehicle accessory for implementing the present invention; and

FIG. 7 illustrates a vehicle power sunroof window as an exemplary motor actuated vehicle accessory for implementing the present invention.

### DESCRIPTION OF THE PREFERRED EMBODIMENTS

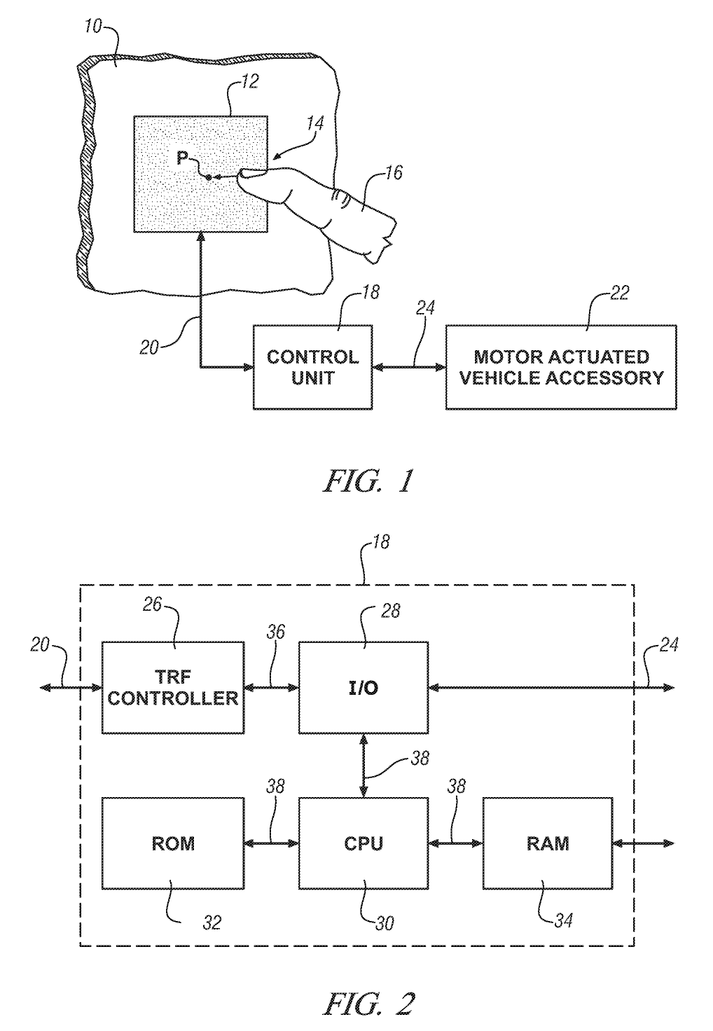

Referring now to FIG. 1, there is shown a schematic view of an exemplary embodiment of the present invention. The numeral 10 designates a portion of window glass of a vehicle window, which includes a transparent touch receptive field 12 for receiving a touch command generally designated as numeral 14. Here, the touch command 14 comprises a touch event represented by the finger of a vehicle occupant 16 touching the touch receptive field 14 at a location designated by the point P. In general, touch command 14 will comprises a sequence of defined touch events that will be described in more detail at a later point in the specification. The touch receptive field 12 is shown electrically coupled to a control unit 18, as indicated by arrowed line 20. Control unit 18 is also electrically coupled to a motor actuated vehicle accessory 22, as indicated by arrowed line 24. It will be understood that the electrical couplings indicated by arrowed lines 20 and 24 are generally formed by one or more electrical conductors or wires to provide signal paths between the illustrated components.

Touch receptive field 12 can be implemented by any number of known techniques used for fabricating touch screen displays in the computer and hand held electronic device art areas. For example, touch receptive field 12 can be formed by applying a transparent electrically conductive coating of indium tin oxide to a region on the vehicle window glass 10, and attaching thin electrodes (not shown) to the corners of such region for inducing current flow in the electrically conductive coating. This is commonly referred to as a capacitive type touch receptive field (or touch screen), which is capable of detecting the occurrence and location (i.e., position) of a touch event based upon changes in the induced current flow in the electrically conductive material caused by the applied touch.

Touch receptive field 12 can also be implemented as an array of separate electrically conductive regions and associated electrodes to enable detection of the occurrence and position of concurrent multiple touch or multi-touch events, e.g., when the vehicle occupant simultaneously applies both a finger and thumb or two fingers to the touch receptive field 12. As will be understood, any number of known touch screen technologies, including capacitive, resistive, pressure, thermal, and/or acoustic sensitive techniques, can be used for implementing the touch receptive field 12 for vehicle window glass 10. The touch receptive field 12 may be formed on the surface of the vehicle window glass 10, with an optional over layer of transparent protective material, or it can even be formed between layers of glass fused together during the forming process for the vehicle window glass 10. The touch receptive field could event be formed on the external surface of the vehicle window glass 10 to permit positioning of vehicles accessories prior to the occupant entering the vehicle.

FIG. 2 shows an exemplary block diagram representation of components included in control unit 18. Control unit 18 comprises a touch receptive field (TRF) controller 26, input/output (I/O) circuitry 28, a central processing unit (CPU) 30, read only memory (ROM) 32, and random access memory (RAM) 34.

CPU 30 is electrically connected to I/O circuitry 28, ROM 32, and RAM 34 via a common electrical bus represented by arrowed lines 38. Under the control of a software program stored in ROM 32, the CPU 30 reads data from and sends data to the I/O circuitry 28, stores data in and retrieves data from RAM 34, and performs arithmetic/logic operations on such data.

TRF controller 26 operates in conjunction with the touch receptive field 12 in a known fashion to detect the occurrence and position of touch events applied by a vehicle occupant 16 to the touch receptive field 12. This touch information is communicated to the I/O circuitry 28 by one or more electrical conductors as indicated by arrowed line 36.

It will also be understood that the I/O circuitry 28 communicates with motor actuated vehicle accessory 22 via one or more electrical conductors as indicated by arrowed line 24. Under the control of CPU 30, the I/O circuitry 28 provides the appropriate control signals to effectuate adjustment of the position of motor actuated vehicle accessory 22, and may receive information related to the operation of the motor actuated vehicle accessory 22, such as its actual position and/or velocity of movement, depending upon the particular application.

In accordance with a software program stored in ROM 32, CPU 30 operates to sequentially sample the touch information communicated to the I/O circuitry 28, and store the sampled touch information data in RAM 34. Based upon the sampled and stored touch information data, CPU 30 then detects the initiation and termination of a valid touch command, and responsively determines appropriate adjustment to be made in positioning the motor actuated vehicle accessory 22. CPU 30 operates in a known fashion to provide control signals, via the I/O circuitry 28, to effectuate the determined positional adjustment of the motor actuated vehicle accessory 22. As indicated previously, I/O circuitry 28 may also receive signals from the motor actuated vehicle accessory 22, which are indicative of actual position and velocity of the electric motor providing the actuation and/or the vehicle accessory. Such information is then available to CPU 30 via bus 38, if required in the positioning process.

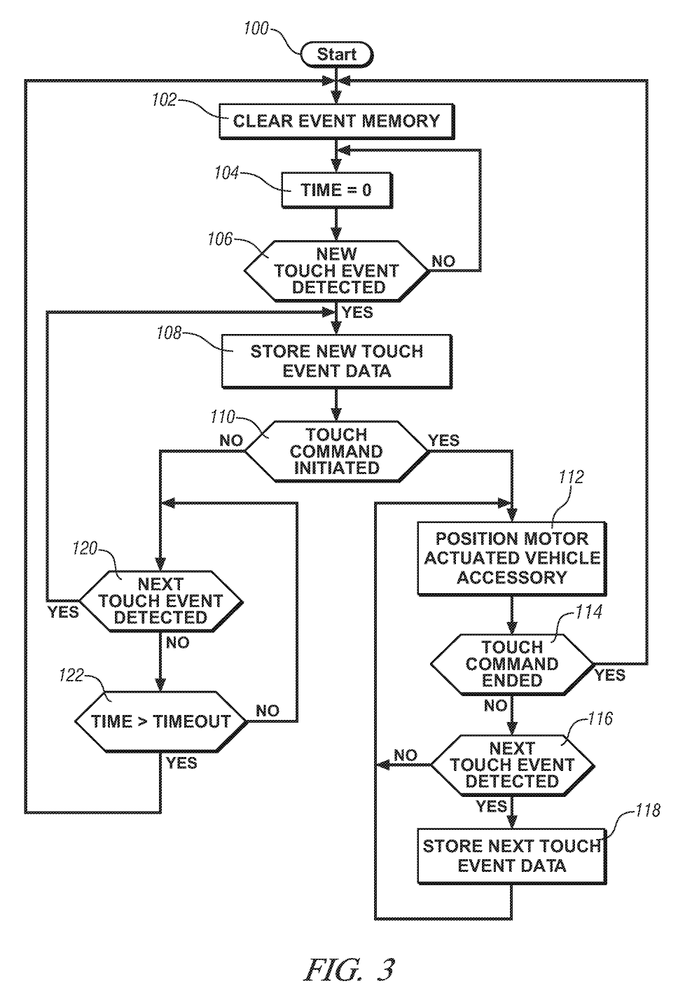

Accordingly, control unit 18 then generally operates to detect a touch command 14 applied to touch receptive field 12, and to adjust the position of motor actuated vehicle accessory 22 in accordance with the detected touch command 14. Control unit 18 is configured to perform these operations by way of a software program stored in ROM 32. The general operational steps carried out by this software program will now be described with reference to an exemplary flow diagram for a software routine illustrated in FIG. 3.

As shown in FIG. 3, the exemplary software routine is implemented as a continuously executed loop for purposes of illustration. Those skilled in the art will recognize that this routine can also be implemented as one of a number of different routines in a continuously executed background loop providing other vehicle control functions.

The routine begins at step 100 when the vehicle is started or the ignition is keyed on to provide battery power to the vehicle accessories. From step 100, the routine passes to step 102, where memory locations in RAM 34 that are used to store touch event data (i.e., event memory) are cleared for initializing the routine.

After step 102, the routine passes to step 104 where an internal software timer is initialized by setting the value of the variable TIME equal to zero. It will be understood, the once initialized, the value of the variable TIME will increase in proportion to elapsed time, until TIME is reset to a zero value by the routine again passing through step 104.

From step 104, the routine then passes to decision step 106, where the routine detects whether a new touch event has occurred. If for example, the vehicle occupant touches the touch receptive field 12 (for example at point P in FIG. 1), the occurrence, and location of the point of contact are communicated by TRF controller 26 to the I/O circuitry 28. By sampling this information, CPU 30 then determines that an initial touch event has occurred and the routine passes to step 108. If the occupant has not touched the touch receptive field 12, then no initial touch event will be detected by CPU 30, and the routine will returns to step 104. The routine will continue executing steps 104 and 106 until a new initial touch event is detected.

In the description that follows, a touch event will be understood to generically include any event detectable by the touch receptive field 12 such an initial touch event; a hold event, a drag event, a release event and other events that will be subsequently be described.

When the occurrence of a new initial touch event is detected, the routine passes from step 106 to step 108, where the type of the touch event (touch, hold, release, etc.), the location (or locations of corresponding multi-touch events), and the corresponding value of TIME provided by the software timer, are stored as touch event data in the event memory section of RAM 34.

The routine then passes to step 110, where a decision is made as to whether a touch command has been initiated. This is accomplished by the CPU 30 scanning the stored touch data entries, and determining whether a predetermined sequence of touch events such as initial touch and release events, initial touch and hold events, initial touch and drag events, or other defined events have occurred, which indicates the initiation of a defined touch command. If such a defined touch command has been initiated, the routine passes to step 112. If such a defined touch command has not yet been initiated, the routine passes to step 120.

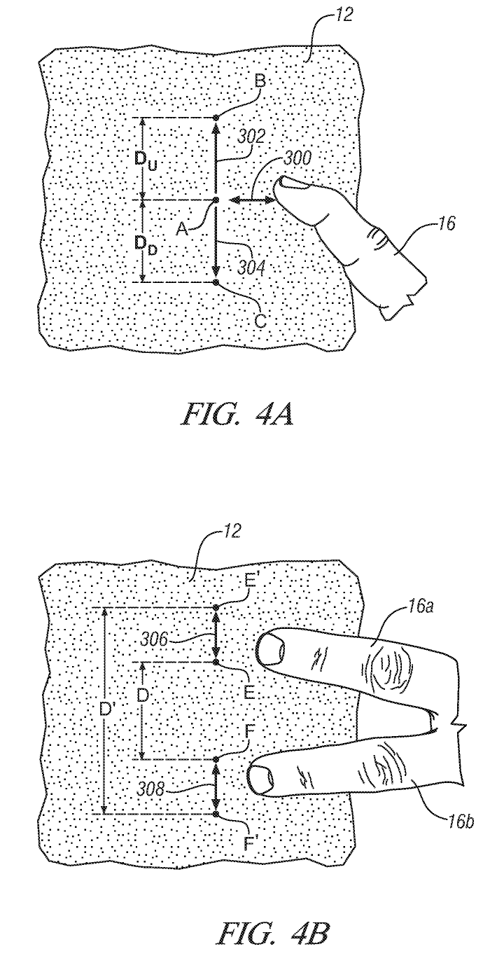

A detailed description touch commands and different touch events defining such touch commands will be provided in the subsequent description associated with FIGS. 4A and 4B. For purposes of the present discussion, it will be assumed that the particular touch command under consideration is defined by an initial touch event, followed by hold event occurring at the same location for at least a predetermined period of time (a defined initial hold time), further followed by a release event, thereby defining what will be referred to hereinafter as a touch-hold-release touch command. If only the initial touch event has occurred (without the hold event) at step 110, insufficient information will exist for CPU 30 to identify the initiation of the touch-hold-release touch command, so the routine will proceed to step 120.

At step 120, a determination is made as to whether a next touch event has occurred (i.e., the hold event). If the occupant has not yet held the initial touch for at least the defined initial hold time, no next touch event will be detected and the routine will proceed to step 122.

At step 122, if the variable TIME is greater than a predetermined maximum TIMEOUT value for all established touch commands with no next touch event detected, the routine disregards the initial touch event, and start over by returning to step 102. If TIME is not greater that the predetermined maximum time TIMEOUT value, the routine returns to step 120 to continue detecting whether the next touch event has occurred (i.e., in this case the hold event). If not, the routine continues to execute steps 120 and 122 until either the next touch event occurs (the hold event) so the routine can branch to step 108, or TIME exceeds the maximum TIMEOUT value causing the routine to start over by branching to step 102.

In branching to step 108 from step 120, the touch data for the next touch event (the hold event) detected as step 120 is stored in RAM 34, and the routine then passes again to step 110.

In returning to step 110 from steps 120 and 108, the initial touch and hold events will have occurred within the predetermined maximum TIMEOUT value for TIME, thereby enabling CPU 30 to determine that the touch-hold-release touch command has been initiated. Accordingly, the routine will then pass to step 112.

At step 112, CPU 30 operates to generate the appropriate control signals for positioning the motor actuated vehicle accessory in response to the initiated touch command, and communicates these signals to the motor actuated vehicle accessory via I/O circuitry 28. It will be understood that information defining each touch command will be stored in ROM 32 along with the corresponding predetermined control operations for appropriately positioning the motor actuated vehicle accessory in accordance with touch events associated with the touch command.

After communicating the necessary control signals via I/O circuitry 28 and electrical coupling 24 to effectuate the predetermined control operations for position the motor actuated vehicle accessory, the routine proceeds from step 112 to step 114. Exemplary touch commands and associated positioning operations for different types of motor actuated vehicle accessories will be provided in the subsequent discussion associated with FIGS. 5-7.

At step 114, a decision is made as to whether the touch command that was determined to have been initiated at step 110 has ended. If the touch command is determined to have ended, the routine branches to step 102 to begin checking for a new touch event associated with a new touch command. However, if at step 114, it is determined that the touch command initiated at step 110 has not ended, the routine passes to step 116.

For the touch-hold-release touch command presently under consideration, this touch command ends when the touch being held is finally released, i.e., the finger of the vehicle occupant 16 is removed from the touch receptive field 12 where it has been held at location P. If the release event has been detected and associated touch data has been stored in event memory, it will be determined at step 114 that the touch command has ended and the routine will branch to step 102. If the release event has not been detected with the associated event data stored in memory, the routine determines that the touch command has not yet ended at step 114, and the routine continues on to step 116.

At step 116, the routine determines whether a next touch event as occurred for the touch command initiated at step 110. If so, the routine passes to step 118, where the touch event data is stored in RAM 34. From step 118, the routine then returns to step 112, where positioning the motor actuated vehicle accessory is continued based upon the touch event detected and stored at step 116 along with the previously detected and stored touch event data. If a next touch event is not detected at step 116, the routine passes to step 112 to continue positioning the motor actuated vehicle accessory based upon the most recently detected touch events stored in the event memory of RAM 34.

Again, for the touch-hold-release touch command presently under consideration, if the release event is not detected as step 116, the routine branches back to step 112 to continue with the appropriate positioning of the motor actuated accessory. If the release event is detected at step 116, the routine will pass to step 118, where the event data associated with the release event is stored in RAM 34, prior to branching back to step 112.

Upon branching back to step 112, with the release event now detected and the associated event data stored, it will be recognized that the touch-hold-release touch command has ended, and positioning of the motor actuated vehicle accessory would then typically terminated. From step 112, the routine then pass to step 114, where detection of the termination of the touch-hold-release touch command causes the routine to branch to step 102 to begin anew.

In carrying out the steps of the routine shown in FIG. 3, CPU 30 then generally operates to detect different touch commands 14 that are applied to touch receptive field 12 by vehicle occupant 16, and adjusts the position of motor actuated vehicle accessory 22 in accordance with the detected touch commands 14.

Touch events that can be used to implement touch commands for the present invention will now be described in conjunction with the illustrations presented in FIGS. 4A and 4B. FIG. 4A shows the finger of a vehicle occupant 16 being applied to a portion of a touch receptive field 12 at a position or location designated by point A. As illustrated by the arrowed line 300, touch receptive field 12 can be initially touched and then released, thereby defining an initial touch event, followed the release of the initial touch event (i.e., a release event), both occurring within a predetermined time period. These two events are typically used to implement what has been referred to hereinafter as a single tap touch command. It will be understood that a double tap touch command can be implemented as an initial touch event, followed by a release event, followed again by an initial touch event and an associated release event, all occurring within a predetermined time period.

A touch-hold-release touch command can be implemented as an initial touch event, followed by a hold event existing at the same location for at least a defined initial hold time, followed eventually by a release event, where the finger of the occupant 16 touches the touch receptive field 12 at a touch location designated for example as point A, holds that touch location for at least the initial hold time, then releases (or removes) the finger from the touched location designated as point A.

Additionally, a touch and drag touch command can be implemented as an initial touch event, followed by a drag event, terminating in a release event, where the finger of the occupant 16 touches the touch receptive field at a touch location such as point A, then drags the finger along the surface of the touch receptive field 12 to a new location (shown in FIG. 4A as either location B or C), followed by a release touch event where the finger of occupant 16 is removed from surface of the touch receptive field 12. As illustrated in FIG. 4A, drag events can be in different directions along the touch receptive field 12 as indicated by arrowed lines 302 and 304, and the drag distance of the finger along the surface can also vary. For example, as the finger of occupant 16 moves along the surface of touch receptive field 12 in the upward direction indicated by arrowed line 302, from point A to point B, the drag distance is defined by the distance DU. Likewise, as the finger of occupant 16 moves along the surface of touch receptive field 12 in the downward direction indicated by arrowed line 304, from point A to point C, the drag distance there is defined by the distance DD.

It will be understood that the above-described touch-hold-release touch command provides CPU 30 with information regarding the location and duration of the hold event, while the touch and drag touch command provides information related to the location, direction, and magnitude of the drag distance, all of which can be used in adjusting the positioning of motor actuated vehicle accessories.

FIG. 4B illustrates a different type of touch command that can be implemented when using a touch receptive field 12, which is capable of detecting multi-touches. As illustrated, this type of multi-touch touch command is initiated when the vehicle occupant 16 concurrently touches the touch receptive field 12 with two fingers 16a and 16b. As shown, fingers 16a and 16b can contact the touch receptive field 12 at respective locations designated at E′ and F′, and fingers 16a and 16b can then be slid over the surface of touch receptive field 12, as indicated by arrowed lines 306 and 308, to new respective locations E and F. These initial multi-touch events and sliding events, when coupled with release events, can be used to implement what will be referred to hereinafter as a closing pinch touch command. Likewise, when fingers 16a and 16b contact the touch receptive field 12 at locations designated respectively as E and F, then slide over the surface to respective locations E′ and F′, as indicated by arrowed lines 306 and 308, these initial multi-touch events and sliding events, when coupled with release events define what will be referred to hereinafter as an opening pinch touch command.

It will be understood that the above-described pinch type touch commands can be used to provide CPU 30 with information regarding the locations of the initial multi-touches, and direction of the pinch (opening or closing), as well as the change in the pinch distance (or touch distance) defined as the difference between distances D′ and D shown in FIG. 4B. This information can then be used by ECU 30 for positioning of motor actuated vehicle accessories in accordance with these different types of pinch touch commands.

It will also be understood that other touch commands in addition to the pinch type touch commands can be implemented based upon the detection of initial multi-touch events. For example, if fingers 16a and 16b are applied to respectively touch the touch receptive field at the locations E and F (or E′ and F′) as initial multi-touch events, followed by associated release events, the distance D (or D′) separating the initial multi-touch locations can be used as touch information by CPU 30 for positioning a motor actuated vehicle accessory. In what follows, this type of touch command will be referred to as a multi-touch and release touch command.

Additionally, a direction defined by the touch locations of the multi-touch and release type touch commands can also be used for positioning motor actuated vehicle accessories. For example, when the two fingers 16a and 16b of occupant 16 touch the touch receptive field 12 at locations E and F (or E′ and F′), a line connecting these two touch locations will generally be in a vertical direction as shown in FIG. 4B. Fingers 16a and 16b could also be applied to touch the touch receptive field 12 at touch locations that define a connecting line in a generally horizontal direction (not shown). Accordingly, CPU 30 could then distinguish between these two different types of multi-touch and release touch commands to provide different positioning of the motor actuated vehicle accessory in accordance with the general direction defined by the locations touched during the multi-touch event and the touch distance between such touch locations.

Referring now to FIGS. 5-7, different exemplary motor actuated vehicle accessories that may be employed in implementing the present invention will now be described.

FIG. 5 shows a vehicle power window, generally designated by numeral 200, which represents an exemplary motor actuated vehicle accessory for implementing the present invention. Power window 200 comprises a vehicle side window glass 202 having a lower edge 202a, and an upper edge 202b, which is slidably mounted in vehicle frame 204. Power window 200 further includes a motor actuator 206, which is mechanically coupled in a known fashion to the lower edge 202a of side window glass 202, as shown by dashed arrowed line 208. Based upon control signals communicated to motor actuator 206 by control unit 18 over electrical conductor(s) represented by dashed line 24, vehicle side window glass 202 can be moved in up or down directions as indicated by arrowed line 210. Accordingly, the upper edge 202b of side window glass 202 can be positioned any distance DW between the indicated fully closed and fully open positions.

For purposes of illustration, vehicle side window glass 202 is further shown as including a first touch receptive field 212 and a second touch receptive field 214. The first touch receptive field has an upper portion 212a and a lower portion 212b. The second touch receptive field 214 is divided into four different defined regions 214a, 214b, 214c, and 214d, which are generally pointed out by way of arrows included in a visual graphic symbol 216 applied to the second touch receptive field 214.

Vehicle side power window 200 further includes a body side molding 218 attached to vehicle frame 204 to cover motor actuator 206 and vehicle side window glass 202, when it is positioned in the fully open position in vehicle frame 204. The vehicle body side molding 218 is shown as having an additional window molding portion 220, which is positioned to cover the upper edge 202b of vehicle side window glass 202, when it is positioned in the fully open position. This window molding portion 220 further includes a slidable member 220b, which can be moved in the up and down directions to provide an opening 224 in the window molding portion 220 for accessing the touch receptive field 212, when side window glass 220 is in the fully open position.

As will now be described, touch receptive field 212 can be utilized to receive different touch commands 14 from vehicle occupant 16 for positioning the side window glass 202 of vehicle power window 200. As described previously, control unit 18 can be programmed to recognize these different touch commands, and provide control signals to the motor actuator 206 for appropriately positioning side window glass 202.

For example, in response to a double tap touch command applied to touch receptive field 212, control unit 18 can be easily programmed to responsively provide control signals to motor actuator 206 to move vehicle side window glass 202 from a present position indicated by DW to the fully open position, thereby providing an express down operational feature for power window 200. Alternatively, control unit 18 can be programmed to move vehicle side window glass 22 to the fully closed position in response to a double tap touch command, thereby providing an express up operational feature for power window 200.

Any number of other combinations of the previously described touch events can also be used for implementing touch commands useful in positioning vehicle power window 200. For example, a single tap or a double tap touch command applied to the upper portion 212a of touch receptive field 212 can be implemented to provide the express up operational feature, while a single tap or double tap touch command applied to the lower portion 212b of touch receptive field 212 can be implemented to provide an express down operational feature. It will be understood that a double tap touch command is usually preferable for these implementations to avoid accidental movement of window glass 202 due to inadvertent touching of touch receptive field 212 that could be interpreted as a single tap type touch command.

The present invention can also be implemented to incrementally move side window glass 202 (up or down) in response to an applied touch-hold-release touch command to region 212a (or 212b), whereby movement of window glass 202 in initiated in the up direction (or down direction) by the initial touch and hold events, with movement continuing during the hold event, and movement terminated upon detection of the release event.

Window glass 202 can also be moved up or down an incremental distance (as defined by a change in DW) depending on the direction (up or down) and magnitude of the drag distance of a touch and drag touch command applied to touch receptive field 212, with the incremental distance of movement of window glass 202 being proportional to the drag distance. Likewise, window glass 202 can be moved either up or down an incremental distance depending upon the direction of the pinch (either opening or closing), and change in pinch distance for a pinch type touch command, where the incremental distance of movement of window glass 202 is proportional to the change in the pinch distance.

It will also be understood that window glass 202 can also be moved up or down an incremental distance depending upon locations touched on a touch receptive field 212 during a multi-touch and release touch command, where directional movement of window glass 202 is determined by a direction defined by the locations touched (horizontal or vertical), with the incremental distance of movement being determined by the distance between the touch locations.

By way of the above examples, it will be understood that control unit 18 can easily be implemented to recognize any number of different touch commands comprising any number and sequence of different touch events for positioning the window glass 202 of power window 200. It will also be understood that touch screen 212 can be used for positioning the window glass of other vehicle power windows, and is not restricted to only controlling the positioning of the window glass 202 upon which it is located.

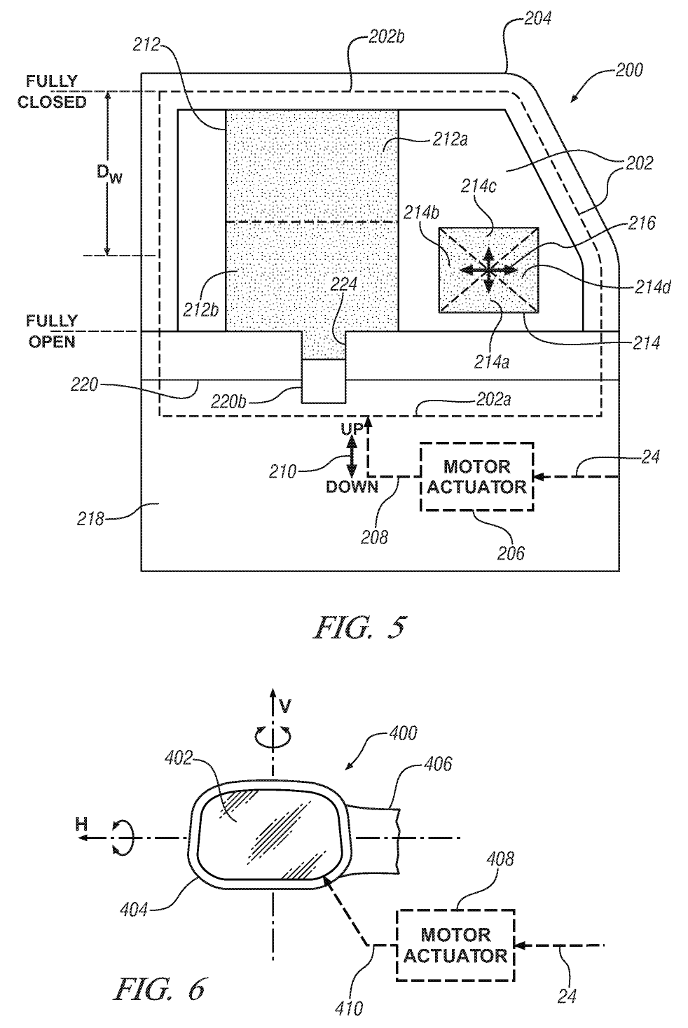

Turning now to FIG. 6, there is shown a vehicle power mirror generally designated as 400, which represents an exemplary alternative for a motor actuated vehicle accessory useful in implementing the present invention. Power mirror 400 comprises a mirror member 402 mounted in a mirror housing 404, which has a support portion 406 for mounting to the exterior side of a vehicle (not shown). As is well known, mirror member 402 is mechanically coupled, as indicated by arrowed line 410, to motor actuator 408, and is pivotably mounted in mirror housing 404 for movement or rotation about both a vertical axis V and a horizontal axis H. Accordingly, mirror member 402 can be tilted upward, downward, to the right, and to the left with respect to mirror housing 404 in response to the appropriate control signals communicated to motor actuator 408 over electrical conductors represented by electrical coupling 24.

An implementation of the invention useful in positioning power mirror 400 will now be described. As indicated in the discussion associated with FIG. 5, touch receptive field 214 comprises a plurality of defined regions 214a, 214b, 214c, and 214d. When control unit 18 is electrically coupled to touch receptive field 214 by way of conductors represented by line 20, it will be understood that control unit 18 can be configured to recognize, when a touch command is applied to any of the different regions 214a-214d, and to determine the specific region to which the touch has been applied. Accordingly, control unit 18 can then provide control signals to rotate mirror element 402 in different directions about the vertical axis V and horizontal axis H, depending upon which of the regions 214a-214d of touch receptive field 214 receives a touch command.

Indicia such as graphic symbol 216 can also be used in conjunction with touch receptive field 214 to provide a means for positioning power mirror 400 that is intuitive to the vehicle occupant 16. As shown, graphic symbol 216 comprises four arrows, each pointing into a different region of touch receptive field 214. Each arrow also points in a different direction, i.e., one arrow points up into region 214c, one arrow points down into region 214a, one arrow points to the left into region 214b, and the other arrow points to the right into region 214d. Accordingly, a vehicle occupant can easily associate each different arrow, and the corresponding region of touch receptive field 214, with a different direction of rotation or tilt, for positioning mirror member 402. For example, it will be intuitive to the vehicle occupant 16 that if region 214c is touched, mirror member 402 will be positioned to tilt up by rotation about the horizontal axis H. Likewise, if region 214a is touched, it will be understood that mirror member 402 will be tilted down by rotation about the horizontal axis H. Similarly, if region 214b or region 214d is touched, it will be easily recognized by the vehicle occupant 16 that mirror member 402 will be respectively tilted to the left or to the right by rotation about vehicle axis V.

Accordingly, the operation of touch receptive field 214 for positioning power mirror 400 is made more intuitive to the vehicle occupant 16 by configuring control unit 18 to recognize which of the regions 214a-214b has received a touch command, and then responsively positioning mirror member 402 in a direction associated with the touched region as described above.

Although any number of different types of touch commands can employed for positioning power mirror 400 in conjunction with touch receptive field 214, the touch-hold-release touch command is particularly useful in that the initial touch and hold events can be used by control unit 18 to initiate movement of mirror member 402, with continuation of such movement during the hold event, followed by termination of the movement of mirror member 402 upon the detection of the release event.

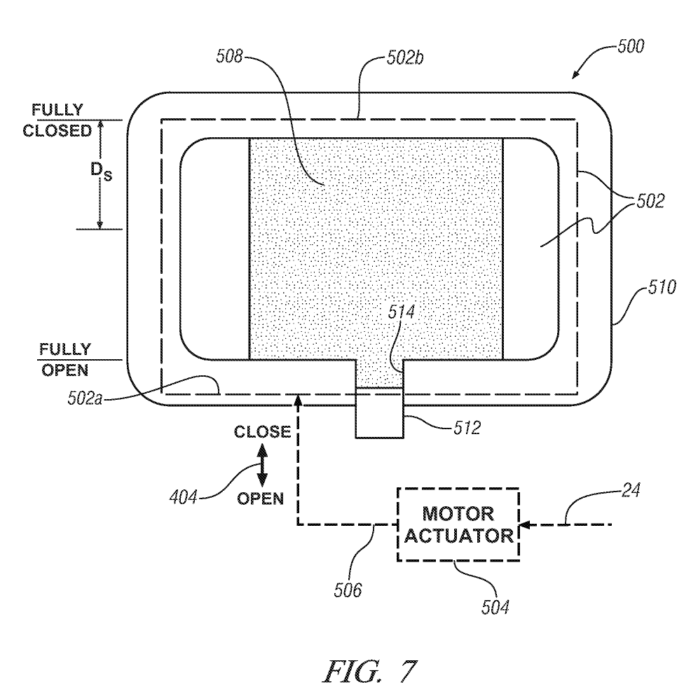

FIG. 7 illustrates an additional exemplary embodiment of the invention where the motor actuated vehicle accessory is a vehicle power sunroof window generally designated by numeral 500. Power sunroof window 500 comprises a sunroof window glass 502, with a first edge 502b and an opposite second edge 502a, which is slidably mounted in a vehicle roof (not shown). Power sunroof window 500 further includes a motor actuator 504, which is mechanically coupled in a known fashion to the second edge 502a of window glass 502, as shown by dashed arrowed line 506. Based upon control signals communicated to motor actuator 504 by control unit 18 over electrical conductor(s) represented by dashed line 24, window glass 502 of vehicle power sunroof window 500 can be moved in open or closed directions, as indicated by arrowed line 507. Accordingly, the first edge 502b of window glass 502 can be positioned any distance DS between the indicated fully closed and fully open positions, where a change in DS represents the distance that window glass 502 is moved.

In this embodiment, the window glass 502 further includes a touch receptive field 508 for receiving a touch command 14 input by a vehicle occupant 16, although the touch receptive field for operating power sunroof window 500 could alternatively be located on the vehicle side window glass 202 as shown in FIG. 5.

Vehicle power sunroof window 500 further includes a roof molding 510 surrounding the opening in the vehicle roof used to accommodate the window glass 502. The roof molding 510 is shown as having a slidable member 512, which can be moved in the up or down directions to provide an opening 514 allowing access to the touch receptive field 508, when sunroof window glass 502 is in the fully open position.

As described previously with regard to touch receptive field 212, touch receptive field 508 can be utilized in the same fashion to receive a variety of different touch commands 14 from vehicle occupant 16 for positioning the window glass 502 of vehicle power sunroof window 500. Such touch commands can include single tap, double tap, touch-hold-release; touch and drag, and the different pinch and multi-touch type touch commands previously described. Control unit 18 can be configured to detect and responsively communicate appropriately assigned control signals to activate motor actuator 408 for positioning the window glass 502 of power sunroof window 500 in accordance with such touch commands.

While the invention has been described by reference to certain preferred embodiments and implementations, it will be understood that numerous changes can be made within the spirit and scope of the described inventive concepts. For example, the present invention may be utilized to position other types of motor actuated vehicle accessories, such as power seat accessories, power pedal assemblies, and the like. Accordingly, it is intended that the invention have the full scope permitted by the language of the following claims, and not be limited to the disclosed embodiments.

1. An apparatus for positioning a motor actuated vehicle accessory, the apparatus comprising:
a vehicle window having a touch receptive field for receiving a touch command applied by a vehicle occupant; and
a control unit coupled to the touch receptive field and the motor actuated vehicle accessory, the control unit being operable to position the motor actuated vehicle accessory in accordance with the touch command applied by the vehicle occupant.

2. The apparatus of claim 1, wherein the touch command comprises an initial touch event, and at least one of a hold event, a release event, and a drag event.

3. The apparatus of claim 1, wherein the touch command comprises a multi-touch event, wherein the touch receptive field is concurrently touched at two different locations.

4. The apparatus of claim 1, wherein the touch receptive field is disposed on a vehicle side window glass.

5. The apparatus of claim 1, wherein the motor actuated vehicle accessory is a vehicle power window having a window glass movable between a fully open position and a fully closed position.

6. The apparatus of claim 5, wherein the touch receptive field is disposed on the window glass of the vehicle power window.

7. The apparatus of claim 5, wherein the touch command comprises a double tap touch command, and the control unit operates to position the window glass of the vehicle power window to the fully open position in response to the double tap touch command.

8. The apparatus of claim 5, wherein the touch command comprises a double tap touch command, and the control unit operates to position the window glass of the vehicle power window to the fully closed position in response to the double tap touch command.

9. The apparatus of claim 5 wherein the touch command comprises touch, hold, and release events, whereby a location on the touch receptive field is touched and held by the vehicle occupant, and the control unit operates to move the window glass of the vehicle power window until the vehicle occupant releases the location touched on the touch receptive field.

11. The apparatus of claim 5, wherein the touch command comprises touch and drag events, whereby the vehicle occupant touches the touch receptive field with a finger, and slides the finger a drag distance along the touch receptive field, and the control unit operates to move the window glass of the vehicle power window a distance proportional to the drag distance.

12. The apparatus of claim 5, wherein the touch command comprises multi-touch events, whereby the vehicle occupant touches the touch receptive field with two fingers at two respective locations separated by a touch distance, and the control unit operates to move the window glass of the vehicle power window a distance proportional to the touch distance.

13. The apparatus of claim 5, wherein the touch command comprises multi-touch and drag events, whereby the vehicle occupant touches the touch receptive field with two fingers at two respective touch locations separated by touch distance, and drags the fingers along the touch receptive field to cause a change in the touch distance, and the control unit operates to move the window glass of the vehicle power window in accordance with the change in the touch distance.

14. The apparatus of claim 6, wherein the window glass of the power window is covered by a vehicle side molding when the window glass in moved to the fully closed position, and the vehicle side molding has an opening to allow touching of the touch receptive field when the window glass is in the fully open position.

15. The apparatus of claim 1, wherein the motor actuated vehicle accessory is a power mirror having a mirror member positioned by rotation about a vertical axis and a horizontal axis.

16. The apparatus of claim 15, wherein the touch receptive field comprises a plurality of defined regions, each defined region corresponding to a different direction of rotation of the mirror element about one of the vertical axis and horizontal axis, and the control unit operates to position the power mirror by determining which of the defined regions receives the touch command.

17. The apparatus of claim 16, wherein the touch receptive field contains a graphic symbol indicative of the different directions of rotation of the mirror element about the vertical and horizontal axes.

18. The apparatus of claim 1, wherein the motor actuated vehicle accessory is a vehicle power sunroof window having a window glass movable between a fully open position and fully closed position.

19. The apparatus of claim 18, wherein the touch receptive field is disposed on the window glass of the vehicle power sunroof window.

20. The apparatus of claim 19, wherein the vehicle power sunroof window has a trim molding with an opening to allow touching of the touch receptive field when the window glass is in the fully open position.

21. A method for positioning a motor actuated vehicle accessory, the method comprising the steps of:
detecting a touch command applied by a vehicle occupant to a touch receptive field disposed on a vehicle window glass; and
positioning the motor actuated vehicle accessory in accordance with the detected touch command
